(19) United States
(12) Patent Application Publication
(10) Pub. No.: US 2026/0074256 A1
(43) Pub. Date: Mar. 12, 2026

(54) VANADIUM BASED FLOW BATTERY STACK

(71) Applicant: Saudi Arabian Oil Company, Dhahran (SA)

(72) Inventors: Ahmad D. Hammad, Dhahran (SA); Issam T. Amr, Al Khobar (SA); Shiyu Wang, Dalian (CN); Shilong Xu, Dalian (CN)

(21) Appl. No.: 18/884,973

(22) Filed: Sep. 13, 2024

(30) Foreign Application Priority Data
Sep. 11, 2024 (GR) 20240100628

(51) Int. Cl. H01M 8/18; H01M 4/86; H01M 8/0258; H01M 8/04186

(52) U.S. Cl. CPC H01M 8/188; H01M 4/86; H01M 8/0258; H01M 8/04186

(57) ABSTRACT

A flow cell battery that includes at least one electrochemical cell. The electrochemical cell includes: an ion exchange membrane; a 1 mm to 4 mm thick anode; an anode current collector; a first bipolar plate disposed between the anode and the anode current collector; a first flow frame that defines first flow channels; a first tank including an anolyte that includes V⁴⁺ and V⁵⁺; a first pump to flow the anolyte from the first tank into the first flow channels; a 1 mm to 4 mm thick cathode; a cathode current collector; a second bipolar plate disposed between the cathode and the cathode current collector; a second flow frame that defines second flow channels; a second tank including a catholyte that includes V²⁺ and V³⁺; and a second pump to flow the catholyte from the second tank into the second flow channels.

### CROSS-REFERENCE TO RELATED APPLICATIONS

This application claims priority to Greek patent application No. 20240100628, filed Sep. 11, 2024, the entire contents of which are incorporated by reference in its entirety.

### TECHNICAL FIELD

This disclosure relates to vanadium-based flow battery stack.

### BACKGROUND

A flow battery is an energy storage technology that stores power as chemical energy in flowing solutions from separate storage tanks, termed catholytes and anolytes. Flow batteries have the potential to be cheaper and more flexible than other competitors, for example, due to their low cost and scalability. Flow batteries can particularly be useful in long-term energy storage compared to other technologies such as pumped storage and compressed air energy storage. In a flow battery, the electrolytes are circulated through electrochemical cells, where they are separated by an ion exchange membrane. Electricity is converted to chemical energy in the electrochemical cells for storage, and then released during discharge. Unique to flow batteries is the ability to independently vary energy and power capacity. Energy capacity is defined by the volume of the electrolyte stored in the tanks and the concentration of redox couple species, whereas the power rating is defined by the size of electrodes and the number of cells in a stack.

### SUMMARY

Implementations of a flow battery electrochemical cell according to the present disclosure can include one or more of the following features. For example, implementations according to the present disclosure can improve the chemical and mechanical stability of the battery system and improve the power density. Various implementations can help improving the application flow battery system, which the characteristics of flexible configuration, short construction cycle, and higher system efficiency. Compared with conventional lithium batteries, flow battery, e.g., vanadium redox-flow battery technology, has the characteristics of large-capacity, higher safety, and long-time energy storage.

An implementation described herein provides a flow cell battery that includes at least one electrochemical cell. The electrochemical cell can include: an ion exchange membrane; an anode having a thickness from 1 mm to 4 mm; an anode current collector electrically connected to the anode; a first bipolar plate disposed between the anode and the anode current collector; a first flow frame disposed between the anode and the anode current collector, the first flow frame defining a plurality of first flow channels; a first tank including an anolyte that includes V⁴⁺ and V⁵⁺; a first pump configured to flow the anolyte from the first tank into the plurality of first flow channels; a cathode having a thickness from 1 mm to 4 mm; a cathode current collector electrically connected to the cathode; a second bipolar plate disposed between the cathode and the cathode current collector; a second flow frame disposed between the cathode and the cathode current collector, the second flow frame defining a plurality of second flow channels; a second tank including a catholyte that includes V²⁺ and V³⁺; and a second pump configured to flow the catholyte from the second tank into the plurality of second flow channels.

In an aspect, combinable with any other aspect, the flow cell battery can include a stack of a plurality of the electrochemical cell.

In an aspect, combinable with any other aspect, the stack has a dimension of 790 mm×640 mm×420 mm, the stack is configured to produce a power of at least 10 kw, and the first and second pumps are both configured to flow the anolyte or the catholyte at a flow rate of at least 5.2 m³/h.

In an aspect, combinable with any other aspect, the flow cell battery can include: a first end plate can include an insulating epoxy resin, in contact with the anode current collector; and a second end plate can include the insulating epoxy resin, in contact with the cathode current collector.

In an aspect, combinable with any other aspect, the insulating epoxy resin can include a glass-reinforced epoxy laminate material.

In an aspect, combinable with any other aspect, the thickness of the anode or the thickness of the cathode is from 2.30 mm to 2.67 mm.

In an aspect, combinable with any other aspect, the thickness of the anode and the thickness of the cathode is from 2.30 mm to 2.67 mm.

In an aspect, combinable with any other aspect, the thickness of the anode or the thickness of the cathode is 2.5 mm.

In an aspect, combinable with any other aspect, the thickness of the anode and the thickness of the cathode is 2.5 mm.

In an aspect, combinable with any other aspect, each of the plurality of first flow channels or each of the plurality of second flow channels has a width from 2 mm to 4 mm.

In an aspect, combinable with any other aspect, each of the plurality of first flow channels has a first width from 2 mm to 4 mm, and each of the plurality of second flow channels have a second width from 2 mm to 4 mm.

In an aspect, combinable with any other aspect, each of the plurality of first flow channels or each of the plurality of second flow channels is separated from each other by a rib having a width from 4 mm to 7 mm.

In an aspect, combinable with any other aspect, each of the plurality of first flow channels is separated from each other by a first rib having a width from 4 mm to 7 mm, and each of the plurality of second flow channels is separated from each other by a second rib having a width from 4 mm to 7 mm.

In an aspect, combinable with any other aspect, each of the plurality of first flow channels is separated from each other by a first rib of 6 mm, and each of the plurality of second flow channels is separated from each other by a second rib of 6 mm.

In an aspect, combinable with any other aspect, each of the plurality of first flow channels or each of the plurality of second flow channels is interlocked.

In an aspect, combinable with any other aspect, a number of inlets for the plurality of first flow channels is less than a number of outlets for the plurality of first flow channels by 1.

In an aspect, combinable with any other aspect, the plurality of first flow channels has 32 inlets, and the plurality of second flow channels has 32 inlets.

An implementation described herein provides a flow cell battery that includes a stack including a plurality of vanadium flow battery electrochemical cells connected tandemly, where each of the plurality of vanadium flow battery electrochemical cells includes: an ion exchange membrane; an anode having a thickness of 2.30 mm to 2.67 mm; a first bipolar plate to separate the plurality of vanadium flow battery electrochemical cells on an anode side; a first flow frame disposed between the anode and the first bipolar plate, the first flow frame defining a plurality of first flow channels; a cathode having a thickness from 2.30 mm to 2.67 mm; a second bipolar plate to separate the plurality of vanadium flow battery electrochemical cells on a cathode side; and a second flow frame disposed between the cathode and the second bipolar plate; an anode current collector electrically connected to an anode side of the stack; a first end plate including an epoxy resin, in contact with the anode current collector; a cathode current collector electrically connected to a cathode side of the stack; a second end plate including an epoxy resin, in contact with the cathode current collector; a first tank including an anolyte, the anolyte including V⁴⁺ and V⁵⁺; a first pump configured to flow the anolyte from the first tank to each of the plurality of vanadium flow battery electrochemical cells, into each of the plurality of first flow channels; a second tank including a catholyte, the catholyte including V²⁺ and V³⁺; and a second pump configured to flow the catholyte from the second tank to each of the plurality of vanadium flow battery electrochemical cells, into each of the plurality of second flow channels.

In an aspect, combinable with any other aspect, the stack has a dimension of 790 mm×640 mm×420 mm.

In an aspect, combinable with any other aspect, the stack is configured to produce a power of at least 10 kW.

In an aspect, combinable with any other aspect, the first and second pumps are both configured to flow the anolyte or the catholyte at a flow rate of at least 5.2 m³/h.

In an aspect, combinable with any other aspect, the anode and the cathode have a thickness of 2.5 mm.

An implementation described herein provides a flow cell battery including: an electrochemical cell that includes: an ion exchange membrane; an anode; an anode current collector electrically connected to the anode; a first bipolar plate disposed between the anode and the anode current collector; a first flow frame disposed between the ion exchange membrane and the first bipolar plate, the first flow frame defining a plurality of first flow channels, each of the plurality of first flow channels having a width of 3 mm and being separated from each other by a rib having a width of 6 mm; a first end plate including an epoxy resin, in contact with the anode current collector; a first tank including an anolyte, the anolyte including V⁴⁺ and V⁵⁺; a first pump configured to flow the anolyte from the first tank into the plurality of first flow channels; a cathode; a cathode current collector electrically connected to the cathode; a second bipolar plate disposed between the cathode and the cathode current collector; a second flow frame disposed between the ion exchange membrane and the second bipolar plate, the second flow frame defining a plurality of second flow channels, each of the plurality of second flow channels having a width of 3 mm and being separated from each other by a rib having a width of 6 mm; a second end plate including the epoxy resin, in contact with the cathode current collector; a second tank including a catholyte, the catholyte including V²⁺ and V³⁺; and a second pump configured to flow the catholyte from the second tank into the plurality of second flow channels.

In an aspect, combinable with any other aspect, the electrochemical cell is configured to generate a current at a current density from 150 mA/cm² to 250 mA/cm².

In an aspect, combinable with any other aspect, the ion exchange membrane includes sulfonated tetrafluoroethylene, the anode and the cathode include a carbon-based material, and the epoxy resin includes a glass-reinforced epoxy laminate material.

In an aspect, combinable with any other aspect, each of the plurality of first flow channels or each of the plurality of second flow channels has a length from 50 mm to 500 mm.

In an aspect, combinable with any other aspect, the flow cell battery includes a stack consisting of 36 units of the electrochemical cells.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF DRAWINGS

FIG. 1 illustrates an example implementation of a flow battery electrochemical cell.

FIG. 2 illustrates components for a flow channel structure of an example implementation of a flow battery electrochemical cell.

FIG. 3 illustrates a flow frame that provides flow channels.

FIG. 4 illustrates a stack of multiple flow battery electrochemical cells.

FIG. 4 illustrates the result of a lifetime test of a vanadium flow battery system using a 2.5 mm electrode.

FIGS. 5-8 illustrate simulation results of computational fluid dynamics (CFD) analysis for different flow channel designs.

FIG. 9 illustrates the result of a lifetime test of a vanadium flow battery system at a pilot scale.

### DETAILED DESCRIPTION

Implementations described herein provide vanadium-based flow battery stack design with the combination of specific electrode dimensions, flow pattern designs, and materials for cell components to improve the overall battery performance. Generally, the power generation by a battery system can be multiplied by combining numerous electrochemical cells into a larger current-producing assembly. For example, cells can be connected in series along a common stacking dimension in the assembly—much like a deck of cards—to form a battery cell stack. Depending on the power output required, such stacks can include a large number, for example, about 36, of individual stacked cells in case of a flow cell battery.

Various implementations described in this disclosure use a unique flow channel design with specific electrode dimensions to improve battery performance when used in a stack without incurring additional production cost. In example implementations, the flow battery cell is characterized by an electrode thickness form 1 mm to 4 mm, for example, about 2.5 mm, and increased number of flow channels, for example, 32 channels, with reduced flow resistance. Further, the electrochemical cell can use a non-metallic epoxy resin for one or more end plates that connect the electrochemical cell to a next cell in a battery stack. Using the epoxy resin for the end plates, ultra-high voltage breakdown due to material corrosion can be avoided, while also reducing the weight of the electrochemical cell. The battery stack according to various implementations of this disclosure can also offer better long-term stability and usability at a local temperature up to 60° C., as well as the improved power density.

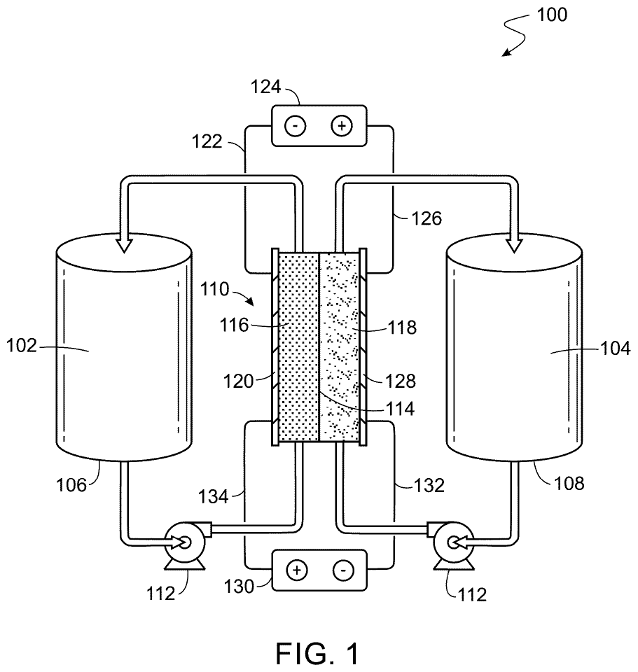

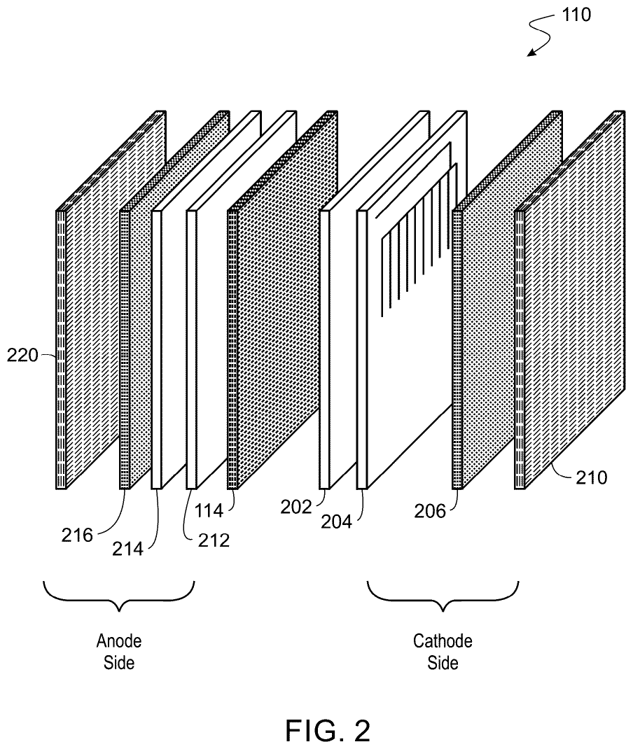

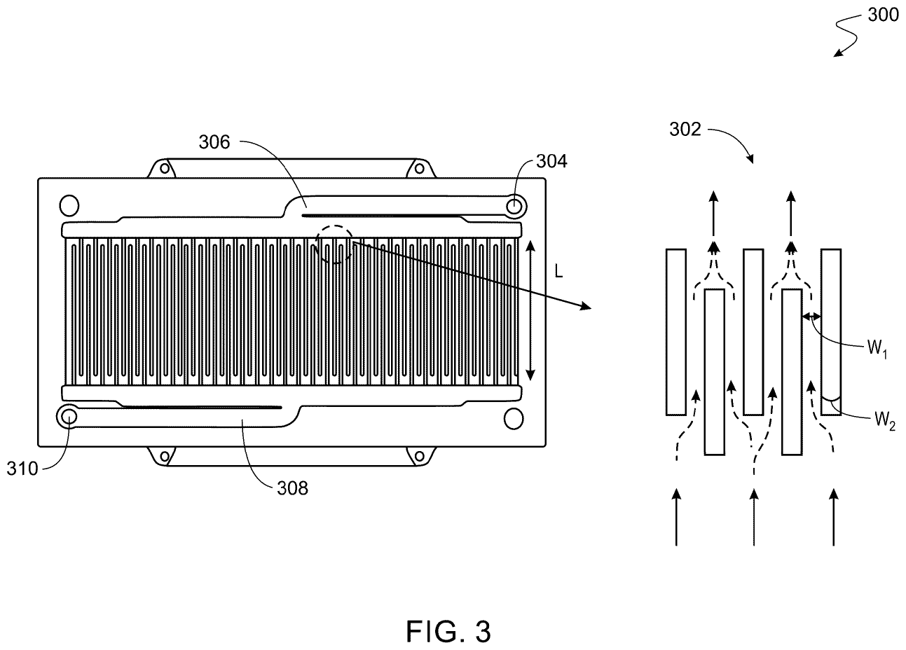

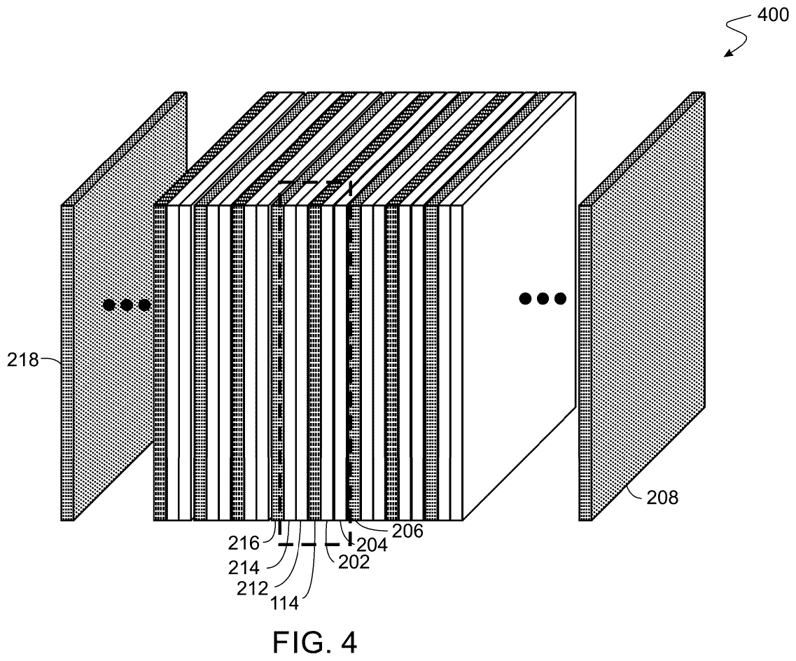

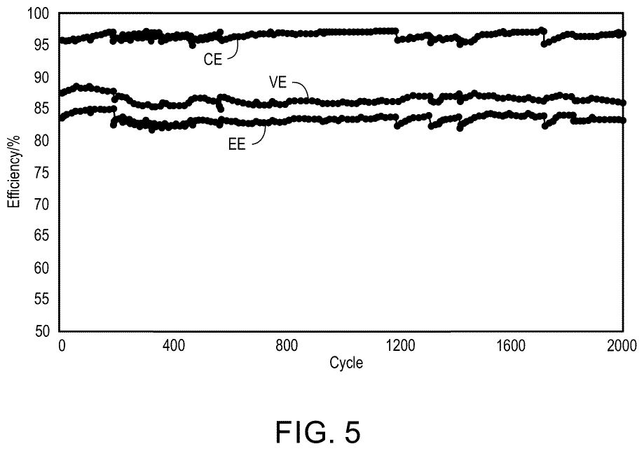

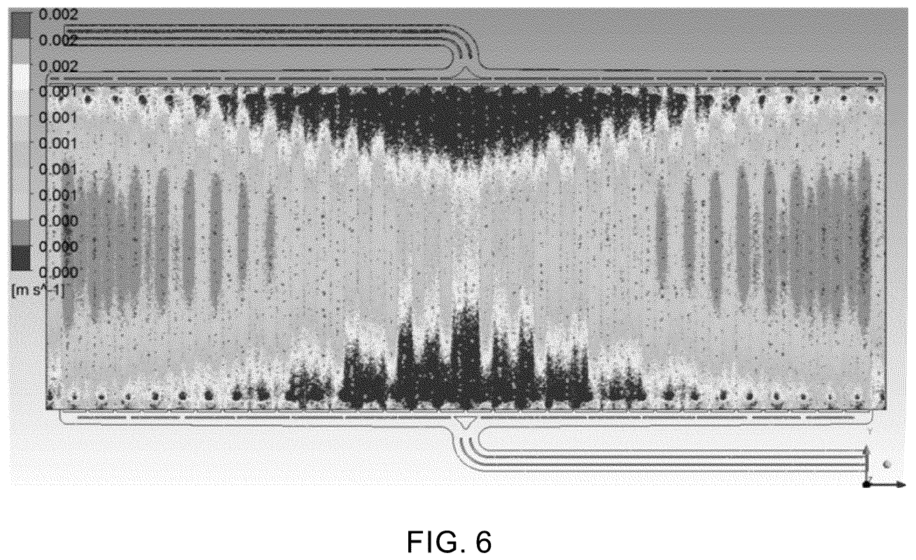

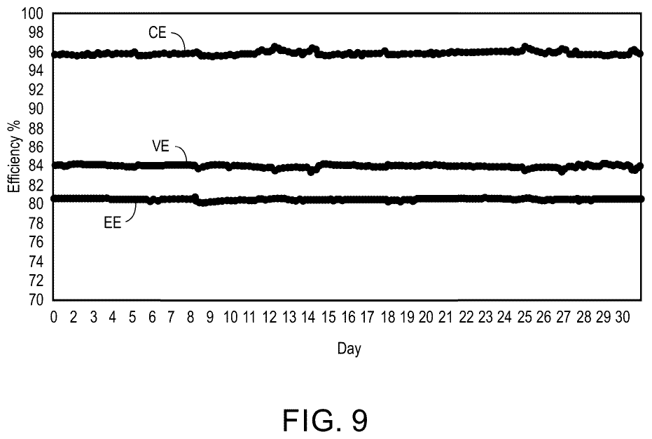

In the following, the design of an example implementation of an electrochemical cell for a flow battery is described referring to FIGS. 1 and 2. The flow design by a flow frame and a stack of multiple electrochemical cells are described referring to FIGS. 3-4. Experimental results for the stability test of a flow battery stack system using a 2.5 mm electrode are described in FIG. 5. Flow characteristics in the flow channels of a cell obtained from computational fluid dynamics (CFD) simulations are illustrated in FIGS. 6-8. Experimental results for the stability test of a flow battery stack system at a pilot scale are described referring to FIG. 9.

### Electrochemical Cell for Flow Battery

FIG. 1 is a drawing of a flow battery 100 using two electrolytes. In the flow battery 100, the energy is stored in electrolytes 102 and 104, which are termed anolyte 102 and catholyte 104, herein. The electrolytes 102 and 104 are stored in tanks 106 and 108 and are separately pumped from the tanks 106 and 108 to an electrochemical cell 110 by dedicated pumps 112.

As illustrated in FIG. 1, an ion exchange membrane 114 can be used in the electrochemical cell 110. The ion exchange membrane 114 separates the electrolytes 102 and 104 to prevent energy loss by short-circuiting, while allowing protons, or other ions, to pass between the sides during charge and discharge cycles and maintain electroneutrality. In example implementations, the ion exchange membrane 114 is a sulfonated tetrafluoroethylene, for example, commercially available under the NAFION® name from DuPont Chemical of Wilmington Virginia. The ion exchange membrane 114 generally controls the efficiency of the flow battery 100, and is a significant contributor to the cost of the flow battery 100.

As the electrolytes 102 and 104 are pumped through the electrochemical cell 110, they pass through channels 116 and 118. Details of the channels 116 and 118 will be further described below referring to FIGS. 2-3.

During the production of power, ions in the anolyte 102 are oxidized, losing electrons to an anode current collector 120. The electrons are transferred by a line 122 to a load 124. After powering the load 124, the electrons are returned to the electrochemical cell 110 by another line 126. The electrons reenter the electrochemical cell 110 from a cathode current collector 128, reducing ions in the catholyte 104.

In various implementations, the flow battery 100 is based on vanadium redox chemistry and is termed the vanadium redox flow battery (VFB). In VFBs, vanadium ions are dissolved in an aqueous acid supporting electrolyte. In example implementations, VFBs are based on V²⁺/V³⁺ and V⁴⁺/V⁵⁺ redox couples.

For a vanadium ion flow cell battery, during discharge, the reaction of the anolyte 102 at the anode current collector 120 is shown in equation 1.

$${V}^{2 +} \to {V}^{3 +} + {e}^{-} , {E}^{0} = - 0.25 V V s SH E \qquad ( 1 )$$

During discharge, the reaction of the catholyte 104 at the cathode current collector 128 is shown in equation 2.

$${VO}^{2 +} + 2 {H}^{+} + {e}^{-} \to {VO}^{2 +} + {H}_{2} O , {E}^{0} = + 1.01 V V s SH E \qquad ( 2 )$$

The anolyte 102 and the catholyte 104 are regenerated during a charging cycle. During the charging cycle a power source 130 removes electrons from the cathode current collector 128 through a line 132, oxidizing ions in the catholyte 104 to an initial state, for example, in the reverse of equation 2. The electrons are provided to the anode current collector 120 from the power source 130 through another line 134, reducing ions in the anolyte 102 to an initial state, for example, in the reverse of equation 1.

In example implementations, the electrolyte in the initial valence state can contain vanadium trichloride, vanadium dichloride oxychloride, ferrous sulfate, sulfuric acid, and hydrochloric acid. Further, in one or more implementations, the electrolyte can also be iron based electrolytes, bromide based electrolytes, chromium based electrolytes, zinc based electrolytes, or organic based electrolytes.

### Flow Channel Structure of an Electrochemical Cell

FIG. 2 is a drawing of an electrochemical cell 110 illustrating components for a flow channel structure. Like numbered items are as described with respect to FIG. 1 and thus not repeated in detail. In various implementations, the flow channel structure enables flow passage of the anolyte 102 and the catholyte 104 for charging and discharging.

As illustrated in FIG. 2, the electrochemical cell 110 can include an anode side and a cathode side separated by the ion exchange membrane 114, and each side can be made of a set of similar or same components. In example implementations, the cathode side includes a cathode 202, a cathode flow frame 204, a bipolar plate or a cathode current collector plate 206, and an end plate 210. The anode side can include an anode 212, an anode flow frame 214, a bipolar plate or an anode current collector 216, and an end plate 220.

In various implementations, the end plates 210, 220 can include an insulating epoxy resin plate. The insulating epoxy resin for the end plates 210, 220 can be, for example, a glass-reinforced epoxy laminate material such as FR-4. In example implementations, the end plates 210, 220 have insulation resistance of greater than 1 MΩ under a 4500 V breakdown test condition.

In various implementations, the current collector plates can be highly conductive materials. In example implementations, the current collector plates include or are made of metals, for example, copper and aluminum. The current collector plates can be clamped to the end plates 210, 220. The wires for the circuitry of the battery system are connected to the current collector plates.

In various implementations, the bipolar plates can include a graphite composite plate. The bipolar plates closing the single cell, thereby serving as a separator from the anode side and cathode side when stacking multiple electrochemical cells. One purpose of the bipolar plates is to allow the stacking of the electrochemical cells 110 for multiplied power generation while preventing ultra-high voltage breakdown.

In various implementations, the flow frames 204, 214, can include a highly conductive graphite material. The flow frames 204, 214 provide flow patterns to guide the electrolyte flow into the cell.

The cathode 202 and the anode 212 can include porous electrodes. In various implementations, these porous electrodes can be carbon-based materials, such as graphite felt and carbon paper. In example implementations, the electrodes 202, 212 can include or be made of a carbon-based electrode, for example, graphite felt, carbon paper or cloth, graphene, and graphitized carbon fiber (GCF).

In example implementations, the electrodes have a thickness from 1 mm to 4 mm, for example, from 2 mm to 3 mm, or from 2.30 mm to 2.67 mm. In one implementation, the anode 212 has a thickness of 2.5 mm.

In example implementations, the cathode 202 has a thickness from 1 mm to 4 mm, for example, from 2 mm to 3 mm, or from 2.30 mm to 2.67 mm. In one implementation, the cathode 202 has a thickness of 2.5 mm. In example implementations, the thickness of the anode 212 and the thickness of the cathode 202 are from 1 mm to 4 mm, for example, from 2 mm to 3 mm, from 2.30 mm to 2.67 mm, or 2.5 mm.

FIGS. 1 and 2 illustrate schematic diagrams of the flow battery 100 and the electrochemical cell 110, and in various implementations, components other than those described above can also be present, or some of the component in FIGS. 1 and 2 can be omitted. For example, the electrochemical cell 110 can include a housing element and a structural support to enable cell stacking.

FIG. 3 illustrates a flow frame 300 that provides flow channels 302. The flow frame 300 can correspond to the cathode flow frame 202, the anode flow frame 206, or both. The electrolytes can be introduced to the flow channels directionally from one side of the flow frame 300 to another side, for example, from top to bottom in FIG. 3. As illustrated in FIG. 3, the flow channels 302 can provide a cross-finger flow field, where the inlet and outlet runners provide the shape of interlocking fingers. The interlocking shape provides a flow pattern such that each inflow bifurcates or is split into multiple channels, and one or more flows are merged as they exit the flow channels 302 as outflow. An example implementation is illustrated in FIG. 3, although other flow patterns that allows effective mixing with minimal flow resistance are also possible. Accordingly, in example implementations, the number of flow inlet and the number of flow outlet are different, depending on the design of interlocking. For example, the flow frame 300 can include 32 flow inlets and 33 flow outlets. In other implementations, the flow frame 300 can provide parallel flow channels with the equal number of flow inlets and flow outlets.

In various implementations, the flow channels 302 are designed with specific dimensions to have a uniform flow pattern with minimal flow resistance. In example implementations, each channel of the flow channels 302 has a width (W₁) from 1 mm to 10 mm, for example, from 2 mm to 4 mm. In one implementation, W₁ can be 3 mm. Each channel can be separated from each other by a rib. In example implementations, each rib has a width (W₂) from 2 mm to 30 mm, for example, from 4 mm to 7 mm. In one implementation, W₂ can be 6 mm. Further, each channel can have a length (L) from 50 mm to 500 mm, for example, from 100 mm to 400 mm.

As illustrated in FIG. 3, the flow frame 300 has an inlet 304 to receive the electrolyte from a distribution line and the electrolyte is guided by an initial flow channel 306 to a first end of the flow channels 302, where the flow can be divided into numerous separate flows. After passing through the flow channels 302, the separate flows are then merged back into a single flow and this merged flow is guided by a final flow channel 308 to an outlet 310.

In various implementations, the flow frame 300 to allow numerous separate flows as FIG. 3 helps maximizing the active cell area available for redox reactions and consequently charging and discharging. In example implementations, the flow frame 300 has from 10 to 50 channels, for example, from 20 to 40 channels.

The inventors of this disclosure recognize that while increasing the number of channels can improve the active cell area, it can also increase fluid processing difficulty. Accordingly, in various implementations, the flow frame 300 can be designed with specific dimensions to mitigate this trade-off. In particular, specific designs with the channel width less than 4 mm and channel rib width less than 7 mm have been demonstrated to enable a uniform distribution of the electrolyte across the flow channels 302.

### Flow Battery Stack

FIG. 4 illustrates a flow battery stack 400 of multiple flow battery electrochemical cells. Like numbered items are as described with respect to FIGS. 1 and 2, and thus not repeated in detail.

In FIG. 4, the flow battery stack 400 includes numerous flow battery electrochemical cells, and each cell, as indicated by a dotted square, can be made of a cathode 202, a cathode flow frame 204, a bipolar plate 206, an ion exchange membrane 114, an anode 212, an anode flow frame 214, and a bipolar plate 216. Each cell is sandwiched by two bipolar plates 206, 216. Each bipolar plate separates individual electrochemical cells hydraulically in terms of the electrolytes, but electrically connects the individual electrochemical cells to enable multiplied power generation.

In various implementations, the flow battery stack 400 includes an anode current collector 218 and a cathode current collector 208 at each end of the series of the electrochemical cells. In example implementations, between a set of the two current collectors, there are from 10 to 40, for example, 36, electrochemical cells.

In example implementations, a modularized flow battery stack can have a dimension of 790 mm×640 mm×420 mm. In example implementations, the modularized flow battery stack is configured to produce a power of at least 10 kW. Further, in one implementation, the modularized flow battery stack can flow the electrolytes at a flow rate of at least 5.2 m³/h.

In various implementations, the modularized flow battery stack can operate stably with a local temperature up to 60° C. To enable the operation at such temperatures, a thermally stable adhesive and sealing materials can be used between the cells to minimize softening an deformation at operation temperatures. Further, the materials are selected to avoid being extruded by the preloading force of stack fastening.

As described above, the flow battery stack design of this disclosure can reduce the material consumption and production cost by replacing the metallic end plate with non-metallic materials, for example, an epoxy resin. This replacement improves the corrosion resistance. Further, the power density can also be improved by reducing the electrolyte flow resistance and better electrolyte distribution. The increased number of flow channels with reduced rib width can result in reduction in electrolyte flow resistance.

### Examples

First, the effect of electrode thickness used in an electrochemical cell was investigated by conducting battery performance experiments. The battery used for the test was a Rongke Power (RKP) conventional experimental single cell, with a 9-in-10-out cross-finger flow field. The electrolyte contained vanadium trichloride, vanadium dichloride oxychloride, sulfuric acid, and hydrochloric acid. The cell further contained two magnetic pumps, corrosion-resistant liquid flow hoses, and fittings. Three parallel single cells were assembled with three different thicknesses of electrodes, 6 mm, 4.35 mm and 2.5 mm, respectively. The single cells were charged and discharged in constant current mode, and current efficiency (CE), voltage efficiency (VE) and energy efficiency (EE) were calculated in a certain cycle under different charging and discharging current densities of 150, 200, and 250 mA/cm². The efficiencies are calculated as follows:

$$CE ( \% ) = \frac{Discharge Current}{Charge Current} \times 100$$

$$VE ( \% ) = \frac{Average Discharge Voltage}{Average Charge Voltage} \times 100$$

$$EE ( \% ) = \frac{Discharge Energy}{Charge Energy} \times 100$$

TABLE 1
Effect of electrode thickness on single cell battery performance

| Current | Thickness 6.0 mm | | | Thickness 4.35 mm | | | Thickness 2.5 mm | | |
|---|---|---|---|---|---|---|---|---|---|
| density (mA/cm²) | CE (%) | VE (%) | EE (%) | CE (%) | VE (%) | EE (%) | CE (%) | VE (%) | EE (%) |
| 150 | 97.1 | 81.8 | 80.1 | 96.7 | 83.8 | 81.0 | 97.0 | 85.2 | 82.7 |
| 200 | 97.5 | 77.2 | 75.3 | 97.0 | 79.6 | 77.2 | 97.3 | 85.3 | 80.1 |
| 250 | 98.2 | 71.1 | 69.8 | 97.4 | 75.8 | 73.8 | 97.5 | 79.0 | 77.0 |

The calculated efficiencies are summarized in Table 1. The single cell with 2.5 mm electrode has the highest EE under all three current density conditions. For example, at the current density of 150 mA/cm², the EE of the 2.5 mm electrode cell is 82.7%, higher than the other two cells (81.0% from the 4.35 mm electrode cell and 80.1% from the 6.0 mm electrode cell).

Next, a lifetime test was performed using the 2.5 mm electrode for 2000 charge-discharge cycles at 60° C. and the current density of 200 mA/cm². The single cell was assembled in the same way for the electrode thickness experiments described above. The results are presented in FIG. 5 and Table 2.

TABLE 2
Battery performance in a lifetime test of 2000 cycles

| | Initial cycle | After 2000 cycles |
|---|---|---|
| CE (%) | 96.1 | 96.5 |
| VE (%) | 86.3 | 86.0 |
| EE (%) | 83.0 | 82.9 |

The initial CE, VE, and EE are 96.1%, 86.3% and 83.0%, respectively. After 2000 cycles, the CE, VE and EE are 96.5%, 86.0% and 82.9%, respectively. The results show no efficiency attenuation, and a long-term stability of the 2.5 mm electrode cell was demonstrated at the operating temperature of 60° C.

Second, the computer fluid dynamics (CFD) simulations were carried out to study three different electrolyte flow patterns and distribution in a flow frame of an electrochemical cell. FIGS. 6-8 illustrate the three CFD simulation results. A flux determined by the simulation is represented in grayscale.

The first flow pattern illustrated in FIG. 6 is based on an interdigital flow field with 16 flow channels. Each flow channel is 3 mm wide and each rib that separates the flow channels is 15 mm wide. As illustrated in FIG. 6, this flow field exhibits high flow resistance, uneven distribution of electrolyte and poor mass transfer effect. The distribution is not uniform both across 16 flow channels horizontally and within each flow channel vertically. These flow pattern issues can be substantially reduced by modifying the flow field design.

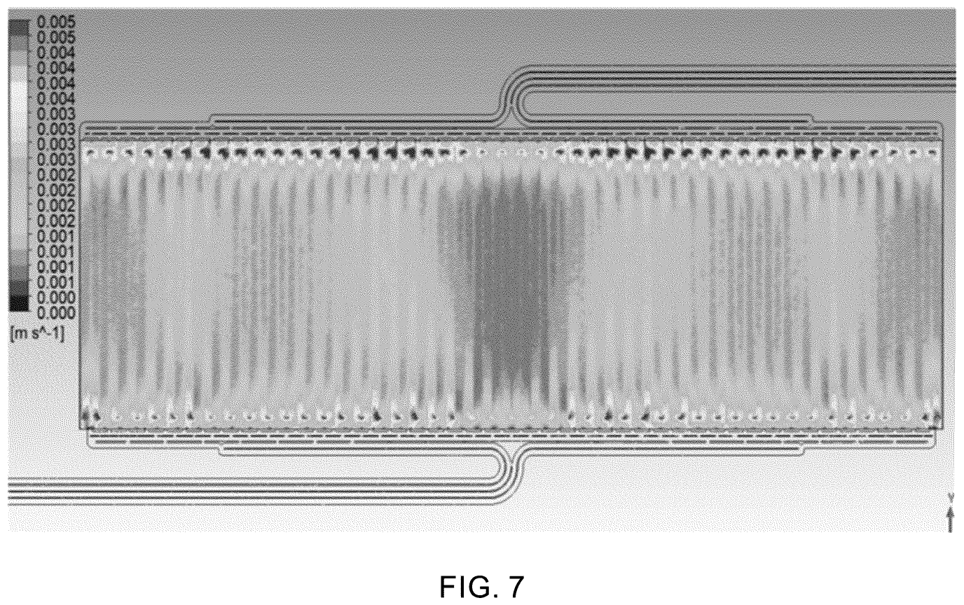

For the second flow pattern illustrated in FIG. 7, the number of flow channels is doubled to 32 and the rib width is reduced from 15 mm to 6 mm. With these modifications, the flow resistance becomes substantially smaller within each flow channel, and the uniformity across the flow channels is also improved. However, there is still some air trapped, causing a zone with no electrolyte in the upper part of the flow channels and uneven distribution on both outer sides. Due to the gas storage at the top of the runner, the gas cannot be discharged, resulting in a portion of the top without the electrolyte. The electrode portion on both sides of the gas storage is not enough to contact the electrolyte.

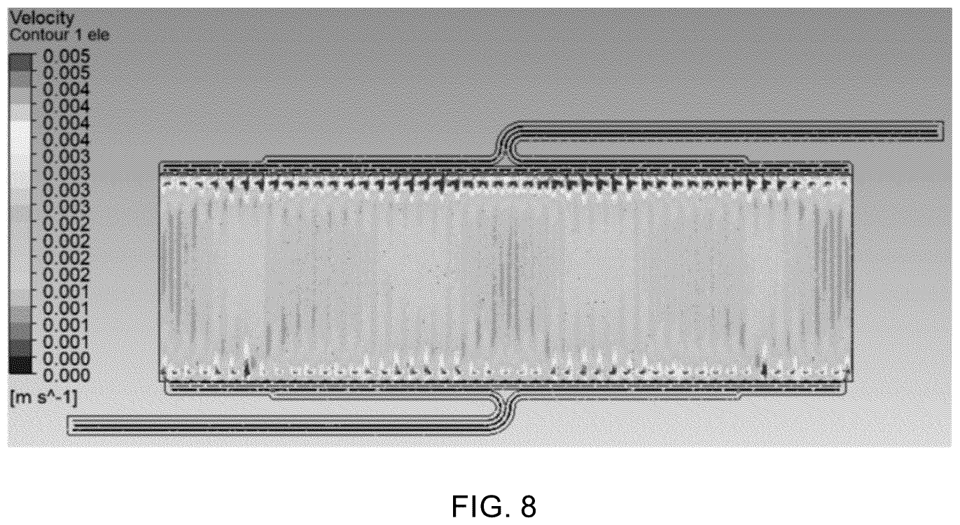

Further improvements in flow distribution have been achieved for the third flow pattern illustrated in FIG. 8. In FIG. 8, the size of the reaction zone is reduced by reducing the width of the flow frame by 50 mm. This adjustment was made to address the gas storage issue found in FIG. 7, where the length of gas stored was about 50 mm. The results after this adjustment show in FIG. 8 that there is no air trapped in flow channels and the electrolyte flows more evenly.

Based on the results of the experiments above, a pilot scale prototype of a vanadium-based flow battery stack has been developed and tested for performance. The flow frame was designed according to the second and third flow patterned examined in the CFD simulation experiments as described above. The test was carried out at a current density of 230 mA/cm², at a temperature of 50° C. for 30 days. The CE, VE, and EE were recorded and plotted in FIG. 9. The initial performance at day 1 and that at day 30 are summarized in Table 3. The initial CE, VE, and EE are 95.7%, 84.1% and 80.5%, respectively. After 30 days life test, the CE, VE and EE are 95.9%, 83.9% and 80.5%, respectively. The results show no efficiency attenuation, and a long-term stability of the prototype was demonstrated at the operating temperature of 50° C.

TABLE 3
Prototype battery performance in a lifetime test of 30 days

| | Day 1 | Day 30 |
|---|---|---|
| CE (%) | 95.7 | 95.9 |
| VE (%) | 84.1 | 83.9 |
| EE (%) | 80.5 | 80.5 |

### Implementations

An implementation described herein provides a flow cell battery that includes at least one electrochemical cell. The electrochemical cell can include: an ion exchange membrane; an anode having a thickness from 1 mm to 4 mm; an anode current collector electrically connected to the anode; a first bipolar plate disposed between the anode and the anode current collector; a first flow frame disposed between the anode and the anode current collector, the first flow frame defining a plurality of first flow channels; a first tank including an anolyte that includes V⁴⁺ and V⁵⁺; a first pump configured to flow the anolyte from the first tank into the plurality of first flow channels; a cathode having a thickness from 1 mm to 4 mm; a cathode current collector electrically connected to the cathode; a second bipolar plate disposed between the cathode and the cathode current collector; a second flow frame disposed between the cathode and the cathode current collector, the second flow frame defining a plurality of second flow channels; a second tank including a catholyte that includes V²⁺ and V³⁺; and a second pump configured to flow the catholyte from the second tank into the plurality of second flow channels.

In an aspect, combinable with any other aspect, the flow cell battery can include a stack of a plurality of the electrochemical cell.

In an aspect, combinable with any other aspect, the stack has a dimension of 790 mm×640 mm×420 mm, the stack is configured to produce a power of at least 10 kw, and the first and second pumps are both configured to flow the anolyte or the catholyte at a flow rate of at least 5.2 m³/h.

In an aspect, combinable with any other aspect, the flow cell battery can include: a first end plate can include an insulating epoxy resin, in contact with the anode current collector; and a second end plate can include the insulating epoxy resin, in contact with the cathode current collector.

In an aspect, combinable with any other aspect, the insulating epoxy resin can include a glass-reinforced epoxy laminate material.

In an aspect, combinable with any other aspect, the thickness of the anode or the thickness of the cathode is from 2.30 mm to 2.67 mm.

In an aspect, combinable with any other aspect, the thickness of the anode and the thickness of the cathode is from 2.30 mm to 2.67 mm.

In an aspect, combinable with any other aspect, the thickness of the anode or the thickness of the cathode is 2.5 mm.

In an aspect, combinable with any other aspect, the thickness of the anode and the thickness of the cathode is 2.5 mm.

In an aspect, combinable with any other aspect, each of the plurality of first flow channels or each of the plurality of second flow channels has a width from 2 mm to 4 mm.

In an aspect, combinable with any other aspect, each of the plurality of first flow channels has a first width from 2 mm to 4 mm, and each of the plurality of second flow channels have a second width from 2 mm to 4 mm.

In an aspect, combinable with any other aspect, each of the plurality of first flow channels or each of the plurality of second flow channels is separated from each other by a rib having a width from 4 mm to 7 mm.

In an aspect, combinable with any other aspect, each of the plurality of first flow channels is separated from each other by a first rib having a width from 4 mm to 7 mm, and each of the plurality of second flow channels is separated from each other by a second rib having a width from 4 mm to 7 mm.

In an aspect, combinable with any other aspect, each of the plurality of first flow channels is separated from each other by a first rib of 6 mm, and each of the plurality of second flow channels is separated from each other by a second rib of 6 mm.

In an aspect, combinable with any other aspect, each of the plurality of first flow channels or each of the plurality of second flow channels is interlocked.

In an aspect, combinable with any other aspect, a number of inlets for the plurality of first flow channels is less than a number of outlets for the plurality of first flow channels by 1.

In an aspect, combinable with any other aspect, the plurality of first flow channels has 32 inlets, and the plurality of second flow channels has 32 inlets.

An implementation described herein provides a flow cell battery that includes a stack including a plurality of vanadium flow battery electrochemical cells connected tandemly, where each of the plurality of vanadium flow battery electrochemical cells includes: an ion exchange membrane; an anode having a thickness of 2.30 mm to 2.67 mm; a first bipolar plate to separate the plurality of vanadium flow battery electrochemical cells on an anode side; a first flow frame disposed between the anode and the first bipolar plate, the first flow frame defining a plurality of first flow channels; a cathode having a thickness from 2.30 mm to 2.67 mm; a second bipolar plate to separate the plurality of vanadium flow battery electrochemical cells on a cathode side; and a second flow frame disposed between the cathode and the second bipolar plate; an anode current collector electrically connected to an anode side of the stack; a first end plate including an epoxy resin, in contact with the anode current collector; a cathode current collector electrically connected to a cathode side of the stack; a second end plate including an epoxy resin, in contact with the cathode current collector; a first tank including an anolyte, the anolyte including V⁴⁺ and V⁵⁺; a first pump configured to flow the anolyte from the first tank to each of the plurality of vanadium flow battery electrochemical cells, into each of the plurality of first flow channels; a second tank including a catholyte, the catholyte including V²⁺ and V³⁺; and a second pump configured to flow the catholyte from the second tank to each of the plurality of vanadium flow battery electrochemical cells, into each of the plurality of second flow channels.

In an aspect, combinable with any other aspect, the stack has a dimension of 790 mm×640 mm×420 mm.

In an aspect, combinable with any other aspect, the stack is configured to produce a power of at least 10 kW.

In an aspect, combinable with any other aspect, the first and second pumps are both configured to flow the anolyte or the catholyte at a flow rate of at least 5.2 m³/h.

In an aspect, combinable with any other aspect, the anode and the cathode have a thickness of 2.5 mm.

An implementation described herein provides a flow cell battery including: an electrochemical cell that includes: an ion exchange membrane; an anode; an anode current collector electrically connected to the anode; a first bipolar plate disposed between the anode and the anode current collector; a first flow frame disposed between the ion exchange membrane and the first bipolar plate, the first flow frame defining a plurality of first flow channels, each of the plurality of first flow channels having a width of 3 mm and being separated from each other by a rib having a width of 6 mm; a first end plate including an epoxy resin, in contact with the anode current collector; a first tank including an anolyte, the anolyte including V⁴⁺ and V⁵⁺; a first pump configured to flow the anolyte from the first tank into the plurality of first flow channels; a cathode; a cathode current collector electrically connected to the cathode; a second bipolar plate disposed between the cathode and the cathode current collector; a second flow frame disposed between the ion exchange membrane and the second bipolar plate, the second flow frame defining a plurality of second flow channels, each of the plurality of second flow channels having a width of 3 mm and being separated from each other by a rib having a width of 6 mm; a second end plate including the epoxy resin, in contact with the cathode current collector; a second tank including a catholyte, the catholyte including V²⁺ and V³⁺; and a second pump configured to flow the catholyte from the second tank into the plurality of second flow channels.

In an aspect, combinable with any other aspect, the electrochemical cell is configured to generate a current at a current density from 150 mA/cm² to 250 mA/cm².

In an aspect, combinable with any other aspect, the ion exchange membrane includes sulfonated tetrafluoroethylene, the anode and the cathode include a carbon-based material, and the epoxy resin includes a glass-reinforced epoxy laminate material.

In an aspect, combinable with any other aspect, each of the plurality of first flow channels or each of the plurality of second flow channels has a length from 50 mm to 500 mm.

In an aspect, combinable with any other aspect, the flow cell battery includes a stack consisting of 36 units of the electrochemical cells.

While this invention has been described with reference to illustrative implementations, this description is not intended to be construed in a limiting sense. Various modifications and combinations of the illustrative implementations, as well as other implementations of the invention, will be apparent to persons skilled in the art upon reference to the description. It is therefore intended that the appended claims encompass any such modifications or implementations.

What is claimed is:

1. A flow cell battery comprising:
at least one electrochemical cell, comprising:
an ion exchange membrane;
an anode having a thickness from 1 mm to 4 mm;
an anode current collector electrically connected to the anode;
a first bipolar plate disposed between the anode and the anode current collector;
a first flow frame disposed between the anode and the anode current collector, the first flow frame defining a plurality of first flow channels;
a first tank comprising an anolyte, the anolyte comprising V⁴⁺ and V⁵⁺;
a first pump configured to flow the anolyte from the first tank into the plurality of first flow channels;
a cathode having a thickness from 1 mm to 4 mm;
a cathode current collector electrically connected to the cathode;
a second bipolar plate disposed between the cathode and the cathode current collector;
a second flow frame disposed between the cathode and the cathode current collector, the second flow frame defining a plurality of second flow channels;
a second tank comprising a catholyte, the catholyte comprising V²⁺ and V³⁺; and
a second pump configured to flow the catholyte from the second tank into the plurality of second flow channels.

2. The flow cell battery of claim 1, further comprising a stack of a plurality of the electrochemical cell.

3. The flow cell battery of claim 2, wherein the stack has a dimension of 790 mm×640 mm×420 mm, the stack is configured to produce a power of at least 10 kW, and the first and second pumps are both configured to flow the anolyte or the catholyte at a flow rate of at least 5.2 m³/h.

4. The flow cell battery of claim 1, further comprising:
a first end plate comprising an insulating epoxy resin, in contact with the anode current collector; and
a second end plate comprising the insulating epoxy resin, in contact with the cathode current collector.

5. The flow cell battery of claim 1, wherein the insulating epoxy resin comprises a glass-reinforced epoxy laminate material.

6. The flow cell battery of claim 1, wherein the thickness of the anode or the thickness of the cathode is from 2.30 mm to 2.67 mm.

7. The flow cell battery of claim 1, wherein the thickness of the anode and the thickness of the cathode is from 2.30 mm to 2.67 mm.

8. The flow cell battery of claim 1, wherein the thickness of the anode or the thickness of the cathode is 2.5 mm.

9. The flow cell battery of claim 1, wherein the thickness of the anode and the thickness of the cathode is 2.5 mm.

10. The flow cell battery of claim 1, wherein each of the plurality of first flow channels or each of the plurality of second flow channels has a width from 2 mm to 4 mm.

11. The flow cell battery of claim 1, wherein each of the plurality of first flow channels has a first width from 2 mm to 4 mm, and each of the plurality of second flow channels have a second width from 2 mm to 4 mm.

12. The flow cell battery of claim 1, wherein each of the plurality of first flow channels or each of the plurality of second flow channels is separated from each other by a rib having a width from 4 mm to 7 mm.

13. The flow cell battery of claim 1, wherein each of the plurality of first flow channels is separated from each other by a first rib having a width from 4 mm to 7 mm, and each of the plurality of second flow channels is separated from each other by a second rib having a width from 4 mm to 7 mm.

14. The flow cell battery of claim 1, wherein each of the plurality of first flow channels is separated from each other by a first rib of 6 mm, and each of the plurality of second flow channels is separated from each other by a second rib of 6 mm.

15. The flow cell battery of claim 1, wherein each of the plurality of first flow channels or each of the plurality of second flow channels is interlocked.

16. The flow cell battery of claim 1, wherein a number of inlets for the plurality of first flow channels is less than a number of outlets for the plurality of first flow channels by 1.

17. The flow cell battery of claim 1, wherein the plurality of first flow channels has 32 inlets, and wherein the plurality of second flow channels has 32 inlets.

18. A flow cell battery comprising:
a stack comprising a plurality of vanadium flow battery electrochemical cells connected tandemly, each of the plurality of vanadium flow battery electrochemical cells comprising:
an ion exchange membrane;
an anode having a thickness of 2.30 mm to 2.67 mm;
a first bipolar plate to separate the plurality of vanadium flow battery electrochemical cells on an anode side;
a first flow frame disposed between the anode and the first bipolar plate, the first flow frame defining a plurality of first flow channels;
a cathode having a thickness from 2.30 mm to 2.67 mm;
a second bipolar plate to separate the plurality of vanadium flow battery electrochemical cells on a cathode side; and
a second flow frame disposed between the cathode and the second bipolar plate;
an anode current collector electrically connected to an anode side of the stack;
a first end plate comprising an epoxy resin, in contact with the anode current collector;
a cathode current collector electrically connected to a cathode side of the stack;
a second end plate comprising an epoxy resin, in contact with the cathode current collector;
a first tank comprising an anolyte, the anolyte comprising V⁴⁺ and V⁵⁺;
a first pump configured to flow the anolyte from the first tank to each of the plurality of vanadium flow battery electrochemical cells, into each of the plurality of first flow channels;
a second tank comprising a catholyte, the catholyte comprising V²⁺ and V³⁺; and
a second pump configured to flow the catholyte from the second tank to each of the plurality of vanadium flow battery electrochemical cells, into each of the plurality of second flow channels.

19. The flow cell battery of claim 18, wherein the stack has a dimension of 790 mm×640 mm×420 mm.

20. The flow cell battery of claim 18, wherein the stack is configured to produce a power of at least 10 kW.

21. The flow cell battery of claim 18, wherein the first and second pumps are both configured to flow the anolyte or the catholyte at a flow rate of at least 5.2 m³/h.

22. The flow cell battery of claim 18, wherein the anode and the cathode have a thickness of 2.5 mm.

23. A flow cell battery comprising:
an electrochemical cell, the electrochemical cell comprising:
an ion exchange membrane;
an anode;
an anode current collector electrically connected to the anode;
a first bipolar plate disposed between the anode and the anode current collector;
a first flow frame disposed between the ion exchange membrane and the first bipolar plate, the first flow frame defining a plurality of first flow channels, each of the plurality of first flow channels having a width of 3 mm and being separated from each other by a rib having a width of 6 mm;
a first end plate comprising an epoxy resin, in contact with the anode current collector;
a first tank comprising an anolyte, the anolyte comprising V⁴⁺ and V⁵⁺;
a first pump configured to flow the anolyte from the first tank into the plurality of first flow channels;
a cathode;
a cathode current collector electrically connected to the cathode;
a second bipolar plate disposed between the cathode and the cathode current collector;
a second flow frame disposed between the ion exchange membrane and the second bipolar plate, the second flow frame defining a plurality of second flow channels, each of the plurality of second flow channels having a width of 3 mm and being separated from each other by a rib having a width of 6 mm;
a second end plate comprising the epoxy resin, in contact with the cathode current collector;
a second tank comprising a catholyte, the catholyte comprising V²⁺ and V³⁺; and
a second pump configured to flow the catholyte from the second tank into the plurality of second flow channels.

24. The flow cell battery of claim 23, wherein the electrochemical cell is configured to generate a current at a current density from 150 mA/cm² to 250 mA/cm².

25. The flow cell battery of claim 23, wherein the ion exchange membrane comprises sulfonated tetrafluoroethylene, the anode and the cathode comprise a carbon-based material, and the epoxy resin comprises a glass-reinforced epoxy laminate material.

26. The flow cell battery of claim 23, wherein each of the plurality of first flow channels or each of the plurality of second flow channels has a length from 50 mm to 500 mm.

27. The flow cell battery of claim 23, further comprising a stack consisting of 36 units of the electrochemical cells.
